(19) United States
(12) Patent Application Publication
(10) Pub. No.: US 2008/0276737 A1
(43) Pub. Date: Nov. 13, 2008

(54) Crank Gear for a Reciprocating Compressor

(76) Inventors: Nicola Campo, Firenze (IT); Simone Pratesi, Firenze (IT); Franco Graziani, Firenze (IT)

Correspondence Address: General Electric Company;Global Patent Operation, 187 Danbury Road, Suite 204, Wilton, CT, 06897-4122, US

(21) Appl. No.: 10/596,576

(22) PCT Filed: Dec. 6, 2004
(86) PCT No.: PCT/EP04/13872

§ 371 Date: Sep. 13, 2006

(30) Foreign Application Priority Data
Dec. 17, 2003 (IT) MI2003A002493

(51) Int. Cl. F16H 21/18

(52) U.S. Cl. 74/42

(57) ABSTRACT

Crank gear (10) for a reciprocating compressor of the type equipped with at least one module which has two lines with two opposite cylinders. The crank gear is suitable for constraining the two cylinders to a crankshaft (20), so as to align the two cylinders, opposite each other with respect to an axis (21) of the shaft (20). The crank gear (10) is equipped with two rods (35), a series of connecting rods (30) and two cross heads (40) and (50). The series of identical connecting rods (30) is symmetrically positioned with respect to the alignment axis (25) of the two cylinders and furthermore the overall barycentre of the series of connecting rods lies on the axis (25) and on the axis (21) of the shaft (20) so that the whole of the shaft (20) is both statically and dynamically balanced.

The present invention relates to a crank gear for a reciprocating compressor, in particular a reciprocating compressor with opposite cylinders.

During the functioning of reciprocating compressors dynamic forces are generated such as centrifugal forces of rotating masses and forces of inertia of alternate masses.

Dynamic forces, and the relative torques, are discharged on the foundations, causing vibrations and stress which may be excessive in some applications.

One of the ways of attenuating these, is to balance the rotating masses and alternate masses of two opposite lines constrained to a crankshaft.

This is normally achieved by installing counter-weights integral with the crankshaft.

The crank gear comprises two opposite cylinders each of which is positioned on a line.

Each line includes a connecting rod connected at a first end to the crankshaft and, at a second end, to a rod connected to a cylinder.

The crank gear comprises at least one module, each of which in turn comprises two lines having opposite cylinders.

The cylinders are not normally aligned and consequently the forces of inertia of the alternate masses create a free, non-balanced torque, for each pair of opposite cylinders.

This causes vibrations and stress.

Crank gears have therefore been produced for attenuating this, with a cross head connected to two connecting rods to align the axes of the two opposite cylinders of a module of the compressor.

In this case, the connecting rods must differ in order to optimize the performance and obtain a uniform reliability.

One of the disadvantages of the known crank gears for reciprocating compressors is that, as they use different connecting rods, the shaft is not balanced.

Another disadvantage is that simulation systems to represent the performance of the rotating mass of the connecting rods, are necessary for balancing the shaft.

This consequently causes an inaccurate balancing as the performance of the rotating masses of the connecting rods is approximated.

An objective of the present invention is to provide a crank gear for a reciprocating compressor which allows a uniform reliability to be obtained.

A further objective is to provide a crank gear for a reciprocating compressor which allows a reduction in the transversal hindrance of the reciprocating compressor itself.

Yet another objective is to provide a crank gear for a reciprocating compressor which optimizes and facilitates the balancing of the compressor itself, increasing the precision and accuracy of the operation itself.

These objectives according to the present invention are achieved by providing a crank gear for a reciprocating compressor as indicated in claim 1.

Further characteristics of the invention are specified in the subsequent claims.

The characteristics and advantages of a crank gear for a reciprocating compressor according to the present invention will appear more evident from the following illustrative and non-limiting description, referring to the enclosed schematic drawings, in which:

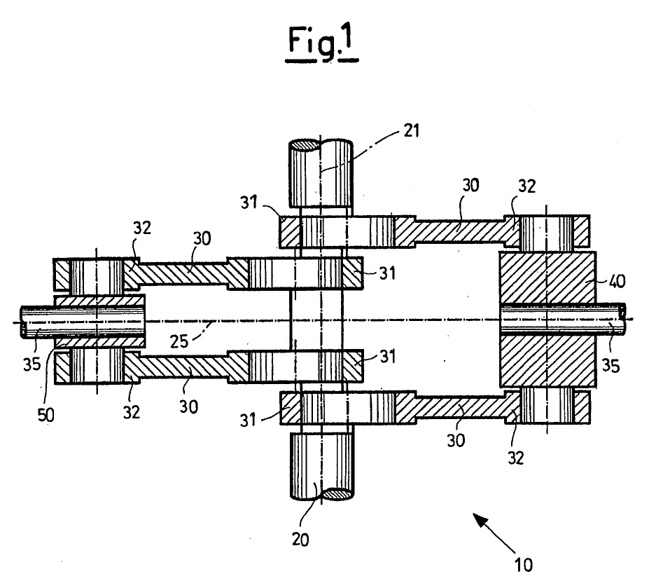

FIG. 1 is a sectional view of a preferred embodiment of a crank gear for a reciprocating compressor according to the present invention.

With reference to the figures, these show a crank gear 10 for a reciprocating compressor which can be applied to a module thereof, said module comprising two lines having two opposite cylinders.

The crank gear is suitable for constraining the two cylinders to a crankshaft 20, keeping them opposite to each other with respect to an axis 21 of the shaft 20.

Said crank gear 10 comprises two rods 35 and a series of connecting rods 30, each of which is respectively constrained at a first end 31 to the shaft 20, and at a second end 32 to one of the two rods 35, each of which is, in turn, connected to one of the two cylinders, respectively.

Said series of connecting rods 30 comprises identical connecting rods 30 symmetrically positioned with respect to an alignment axis 25 of the two cylinders.

Furthermore, the connecting rods 30 of the series of connecting rods 30 are connected in pairs to the two rods 35 by means of two cross heads respectively, a cross head 40 and a cross head 50, respectively.

The connecting rods (30) are preferably connected in pairs to a cross head (40) and a cross head (50) respectively by means of two respective pins with which these are equipped.

Said two pins are preferably positioned at the ends of the body of each cross head (40) and (50) and are aligned with respect to the centre of the body itself.

According to a preferred embodiment of the present invention, said series of connecting rods 30 are four identical connecting rods.

The connecting rods 30 of said series of connecting rods 30 are arranged in an equal number with respect to the axis 21 of the shaft 20 and positioned symmetrically with respect to the alignment axis 25 of the two cylinders.

Furthermore the overall barycentre of the complete series of connecting rods 30 lies on the axis 25 and on the axis 21 of the shaft 20.

The use of a single type of connecting rods, in particular identical connecting rods 30, operating under the same conditions, allows a functional and structural symmetry to be obtained for the crank gear 10.

This allows the engineering of the connecting rods themselves to be optimized, at the same time obtaining a uniform reliability.

The accuracy of the shaft 20 balancing, moreover, depends on the precision of the instruments used, and is consequently thus increased.

The shaft is in fact balanced both statically and dynamically regardless of the crank gear 10.

The balancing of the shaft is obtained by means of a common rotor balancer, avoiding the necessity of installing simulators to represent the rotating parts of the mass of connecting rods.

Each connecting rod 30 of the series of connecting rods 30 is produced with the same inertia characteristics, mass and mass centre within the precision limits of the measuring instruments.

The remaining components of said at least one module of the reciprocating compressor, i.e. cross heads 40 and 50, the two rods 35, the two opposite cylinders and possible ballasts not shown in the figure, are also preferably produced with equal masses for each of the two lines of said at least one module.

The particular crank gear described in the present invention enables the use of special cross heads which allow a reduction in the transversal hindrance of the machine, particularly advantageous for large dimensional compressors.

It can thus be seen that the crank gear for a reciprocating compressor according to the present invention achieves the objectives indicated above.

Numerous modifications and variants can be applied to the crank gear for a reciprocating compressor of the present invention, thus conceived, all included in the same inventive concept.

Furthermore, in practice, the materials used, as also the dimensions and components, can vary according to technical demands.

1. A crank gear (10) for a reciprocating compressor suitable for constraining two cylinders of a module of the reciprocating compressor to a crankshaft (20), keeping them opposite each other with respect to an axis (21) of the shaft (20), said crank gear (10) comprising two rods (35) and a series of connecting rods (30) each of which is respectively constrained at a first end (31) to the shaft (20), and at a second end (32) to one of the two rods (35), each of which is, in turn, connected to one of the two cylinders, respectively, characterized in that said series of connecting rods (30) comprises identical connecting rods (30) symmetrically positioned with respect to an alignment axis (25) of the two cylinders, and characterized in that said connecting rods (30) of the series of connecting rods (30) are connected in pairs to the two rods (35) by means of a cross head (40) and a cross head (50), respectively.

2. The crank gear (10) according to claim 1, characterized in that said series of connecting rods (30) are connected in pairs to a cross head (40) and a cross head (50) respectively, by means of two respective pins with which these are equipped.

3. The crank gear (10) according to claim 2, characterized in that said two pins are situated at the ends of the body of each cross head (40) and (50) and are aligned with respect to the centre of the body itself.

4. The crank gear (10) according to claim 1, characterized in that said series of connecting rods (30) are four identical connecting rods.

5. The crank gear (10) according to claim 1, characterized in that the connecting rods (30) of said series of connecting rods (30) are arranged in an equal number with respect to the axis (21) of the shaft (20).

6. The crank gear (10) according to claim 1, characterized in that the overall barycentre of the complete series of connecting rods (30) lies on the axis (25) and on the axis (21) of the shaft (20).

7. A reciprocating compressor comprising at least one module equipped with a crank gear (10) according to claim 1, characterized in that the shaft (20) is both statically and dynamically balanced.

8. (canceled)
